(19) United States
(12) Patent Application Publication
(10) Pub. No.: US 2022/0396116 A1
(43) Pub. Date: Dec. 15, 2022

(54) AIR CONDITIONING CONTROL APPARATUS AND METHOD

(71) Applicants: HYUNDAI MOTOR COMPANY, Seoul (KR); Kia Corporation, Seoul (KR)

(72) Inventors: Gyu Sik Hong, Yongin-si (KR); Seo Jung Kim, Seoul (KR)

(73) Assignees: HYUNDAI MOTOR COMPANY, Seoul (KR); Kia Corporation, Seoul (KR)

(21) Appl. No.: 17/545,296

(22) Filed: Dec. 8, 2021

(30) Foreign Application Priority Data
Jun. 11, 2021 (KR) 10-2021-0076186

(51) Int. Cl. B60H 1/00

(52) U.S. Cl. CPC B60H 1/0075; B60H 1/00807

(57) ABSTRACT

An air conditioning control apparatus and method, may include a photo sensor that detects a quantity of insolation incident to an interior of a vehicle, and a processor that sets a correction ratio according to window tinting information of the vehicle, corrects a photo sensor value detected by the photo sensor by use of the set correction ratio, and controls indoor air conditioning of the vehicle according to the corrected photo sensor value.

### CROSS-REFERENCE TO RELATED APPLICATION

The present application claims priority to Korean Patent Application No. 10-2021-0076186, filed on Jun. 11, 2021, the entire contents of which is incorporated herein for all purposes by this reference.

### BACKGROUND OF THE INVENTION

### Field of the Invention

The present invention relates to an air conditioning control apparatus and method.

### Description of Related Art

A full automatic temperature control (FATC) system that maintains a comfortable environment by automatically adjusting the indoor temperature of a vehicle based on a temperature set by a user (e.g., a driver or a passenger) has been applied to the vehicle. When the user sets the temperature, the FATC system (air conditioning system) may detect a quantity of insolation, outdoor temperature, and indoor temperature by use of a photo sensor and a temperature sensor, and perform air conditioning control based on the detection values of each sensor.

Because such an air conditioning system development does not take into account the presence or absence of tinting of the vehicle's windshield, when the vehicle's windshield is tinted, an error may occur in the insolation measurement value of the photo sensor due to the tinting of the vehicle's windshield, which may also cause problems in the air conditioning control. For example, although the outdoor temperature is low but the sunlight is strong, the heating is operated despite the proper indoor temperature, consuming unnecessary heating energy. Furthermore, in the case of electric vehicles, unnecessary heating energy consumption causes a decrease in indoor comfort and deterioration of fuel efficiency.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing an air conditioning control apparatus and method configured for correcting a photo sensor value based on a window tinting specification applied to a vehicle and controlling indoor air conditioning by use of the corrected photo sensor value.

The technical problems to be solved by the present inventive concept are not limited to the aforementioned problems, and any other technical problems not mentioned herein will be clearly understood from the following description by those skilled in the art to which various exemplary embodiments of the present invention pertains.

According to various aspects of the present invention, an air conditioning control apparatus includes a photo sensor that detects a quantity of insolation incident to an interior of a vehicle, and a processor that sets a correction ratio according to window tinting information of the vehicle, corrects a photo sensor value detected by the photo sensor using the set correction ratio, and controls indoor air conditioning of the vehicle according to the corrected photo sensor value.

The window tinting information may include at least one of whether window tinting is present, a window tinting manufacturer, or a window tinting paper type.

The processor may determine the corrected photo sensor value by multiplying the detected photo sensor value by the set correction ratio.

The processor may perform the air conditioning control in consideration of at least one of an outdoor temperature or an indoor temperature of the vehicle together with the corrected photo sensor value.

The processor may control an auto light function of the vehicle based on the corrected photo sensor value.

The photo sensor may be attached to a windshield of the vehicle or provided on an upper end portion of a crash pad of the vehicle.

The correction ratio may be set after initial window tinting or after window tinting change.

According to various aspects of the present invention, an air conditioning control method includes setting a correction ratio based on window tinting information of a vehicle, detecting a photo sensor value corresponding to a quantity of insolation incident to an interior of the vehicle using a photo sensor, correcting the detected photo sensor value using the correction ratio, and controlling indoor air conditioning of the vehicle according to the corrected photo sensor value.

The window tinting information may include at least one of whether window tinting is present, a window tinting manufacturer, or a window tinting paper type.

The correcting of the photo sensor value may include determining the corrected photo sensor value by multiplying the detected photo sensor value by the set correction ratio.

The controlling of the indoor air conditioning may include performing the air conditioning control in consideration of at least one of an outdoor temperature or an indoor temperature of the vehicle together with the corrected photo sensor value.

The air conditioning control method may further include controlling an auto light function of the vehicle based on the corrected photo sensor value.

The setting of the correction ratio may include setting the correction ratio after initial window tinting or after window tinting change.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram illustrating an air conditioning control apparatus according to various exemplary embodiments of the present invention;

FIG. 2 is a graph illustrating photo sensor values according to the presence or absence of window tinting related to the present invention;

FIG. 3 is a view exemplarily illustrating an application example of a dual photo sensor according to various exemplary embodiments of the present invention;

FIG. 4 is a flowchart illustrating an air conditioning setting method according to various exemplary embodiments of the present invention;

FIG. 5 is a view exemplarily illustrating an example of an air conditioning setting screen related to the present invention; and

FIG. 6 is a flowchart illustrating an air conditioning control method according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, various exemplary embodiments of the present invention will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present invention, a detailed description of the related known configuration or function will be omitted when it is determined that it interferes with the understanding of the exemplary embodiment of the present invention.

In describing the components of the exemplary embodiment according to various exemplary embodiments of the present invention, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

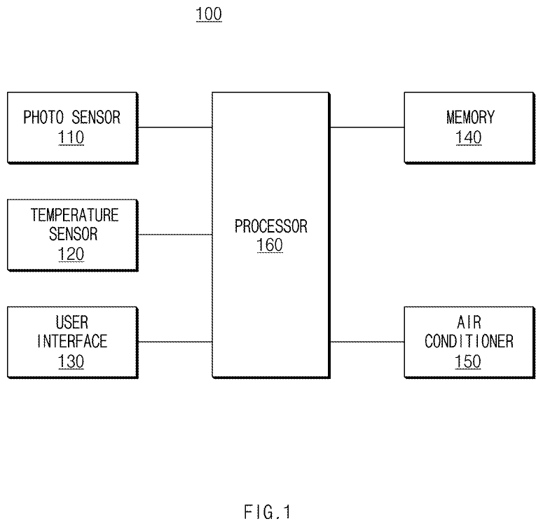

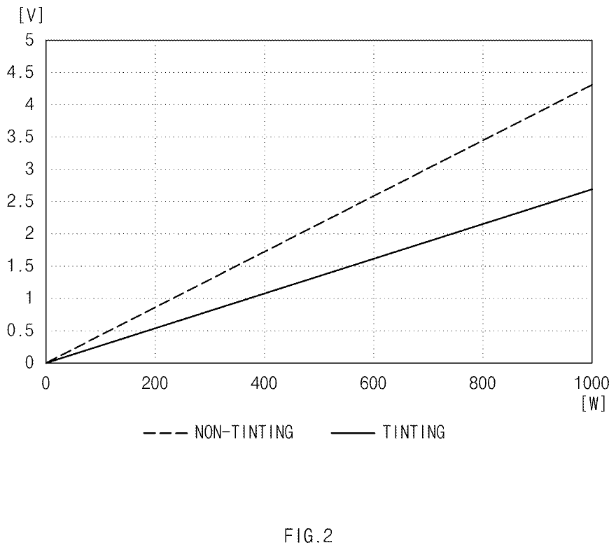

FIG. 1 is a block diagram illustrating an air conditioning control apparatus according to various exemplary embodiments of the present invention. FIG. 2 is a graph illustrating photo sensor values according to the presence or absence of window tinting related to the present invention.

Referring to FIG. 1, an air conditioning control apparatus 100 may include a photo sensor (or photodetector) 110, a temperature sensor 120, a user interface (Human Interface Device: HID) 130, a memory 140, an air conditioner 150, and a processor 160.

The photo sensor 110 may measure (detect) a quantity of insolation. The photo sensor 110 may convert light energy into electrical energy (e.g., voltage) and output the converted electrical energy. The photo sensor 110 may be attached to the windshield of a vehicle or provided on an upper end portion of a crash pad of the vehicle. The photo sensor 110 may output a voltage corresponding to the quantity of insolation incident through the windshield of the vehicle. The photo sensor 110 may output a voltage corresponding to the quantity of insolation, and as shown in Table 1 and the graphs in FIG. 2, the photo sensor value may vary according to the presence or absence of vehicle tinting. That is, when the same quantity of insolation is incident on the windshield of the vehicle, the photo sensor value detected when the vehicle is tinted is smaller than that detected when the vehicle is not tinted.

TABLE 1

| Quantity of | | |
|---|---|---|
| Insolation | Non-tinting | Tinting |
| [W] | [V] | [V] |
| 0 | 0 | 0 |
| 100 | 0.423 | 0.266 |
| 200 | 0.860 | 0.541 |
| 300 | 1.288 | 0.810 |
| 400 | 1.717 | 1.080 |
| 500 | 2.148 | 1.351 |
| 600 | 2.578 | 1.621 |
| 700 | 3.009 | 1.892 |
| 800 | 3.438 | 2.162 |
| 900 | 3.869 | 2.433 |
| 1000 | 4.299 | 2.703 |

Temperature sensors 120 may be provided inside and outside the vehicle to measure (detect) the indoor temperature and the outdoor temperature, respectively. The temperature sensor 120 may include at least one of a thermocouple, a thermistor, a resistance temperature detector (RTD), an infrared sensor, and the like. The user interface 130 may be an input/output device configured for interacting with a user. The user interface 130 may generate data corresponding to a user's manipulation, and may output visual information, auditory information, and/or tactile information. The user interface 130 may include a keyboard, a keypad, a button, a switch, a touchpad, a touch screen, a display, speaker, or the like. The user interface 130 may be implemented as an audio video navigation (AVN), an infotainment system, or the like.

The memory 140 may store a database in which a correction ratio corresponding to a window tinting specification, that is, a tuning factor is defined. The memory 140 may store a preset indoor temperature, a preset correction ratio, and the like. The memory 140 may be a non-transitory storage medium that stores instructions that are executed by the processor 160. The memory 140 may be implemented with at least one of storage medium (recording medium) such as a flash memory, a hard disk, a solid state disk (SSD), a secure digital card (SD), a random access memory (RAM), a static random access memory (SRAM), a read only memory (ROM), a programmable read only memory (PROM), an electrically erasable and programmable ROM (EEPROM), an erasable and programmable ROM (EPROM), a register, an embedded multimedia card (eMMC), an a universal flash storage (UFS), and the like.

The air conditioner 150 may control the temperature, humidity, air cleanliness and/or air flow of the vehicle interior. The air conditioner 150 may include a blower motor, an evaporator, a heater core, a temp door actuator, and the like.

The processor 160 may control the overall operation of the air conditioning control apparatus 100. The processor 160 may include at least one of processing devices such as an application specific integrated circuit (ASIC), a digital signal processor (DSP), a programmable logic device (PLD), field programmable gate arrays (FPGAs), a central processing unit (CPU), a microcontroller, a microprocessor, and the like.

When the indoor temperature is set by a user, the processor 160 may control the air conditioner 150 based on the set indoor temperature to adjust the indoor temperature of the vehicle. The processor 160 may determine the heat load in the vehicle based on at least one of the quantity of insolation, the indoor temperature, and/or the outdoor temperature detected by the photo sensor 110 and the temperature sensor 120. The processor 160 may control the air conditioner 150 based on the determined heat load to adjust the air condition inside the vehicle.

When the quantity of insolation is detected by use of the photo sensor 110, the processor 160 may correct the detected quantity of insolation, that is, the photo sensor value according to the presence or absence of window tinting of the vehicle. The processor 160 may determine whether to correct the photo sensor value detected by the photo sensor 110 according to the presence or absence of tinting of the vehicle. The processor 160 may determine to correct the photo sensor value when the vehicle is tinted. When the vehicle is not tinted, the processor 160 may determine not to correct the photo sensor value.

The processor 160 may set the correction ratio based on the tinting specification applied to the vehicle after the initial tinting or after the tinting change, that is, the tinting information. The window tinting information may include the presence or absence of window tinting, a window tinting maker, and/or a type of window tinting paper (window tinting film). The processor 160 may enter an air conditioning setting mode according to data output from the user interface 130 (e.g., a user input) and select tinting information such as presence or absence of tinting, a tinting manufacturer and/or a type of tinting paper. The processor 160 may set the correction ratio corresponding to information selected with reference to the database stored in the memory 140, that is, window tinting information input by a user.

The processor 160 may correct the photo sensor value output from the photo sensor 110 by use of the set correction ratio. The processor 160 may determine the corrected photo sensor value SV_{corrected} by use of following Equation 1.

SV_{corrected}=SV_{measured}×F [Equation 1]

Where SV_{measured} is a photo sensor value measured by the photo sensor 110, and ‘F’ is a correction ratio.

The processor 160 may perform air conditioning control based on the corrected photo sensor value. For example, the processor 160 may limit heating when the outside temperature is lower than a reference temperature but the quantity of insolation measured by the photo sensor 110 is higher than a reference value.

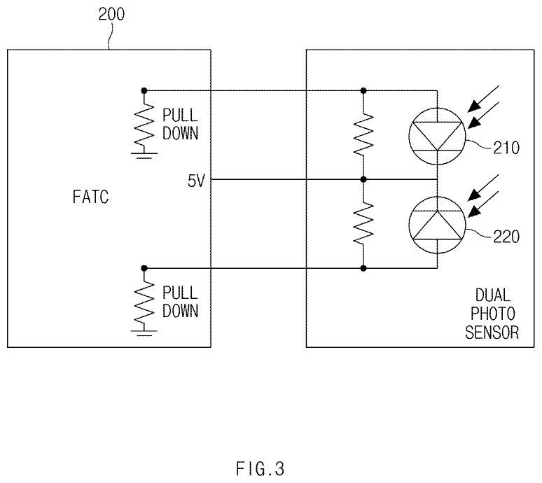

FIG. 3 is a view exemplarily illustrating an application example of a dual photo sensor according to various exemplary embodiments of the present invention.

As shown in FIG. 3, a full automatic temperature control (FATC) device 200, which is an air conditioning control apparatus, may detect the quantity of insolation incident through the windshield of the vehicle by use of a dual photo sensor. The dual photo sensor may include a first photodiode 210 and a second photodiode 220. The first photodiode 210 may be provided at a driver's seat side, and the second photodiode 220 may be provided at a passenger's seat side. A cathode of the first photodiode 210 and a cathode of the second photodiode 220 may be connected to each other. The FATC device 200 may apply a voltage of 5 V to a contact point between the first photodiode 210 and the second photodiode 220. The anode of the first photodiode 210 and the anode of the second photodiode 220 may be connected to a pull-down resistor, respectively. The pull-down resistor may be used to prevent a signal input to the FATC device 200 from floating.

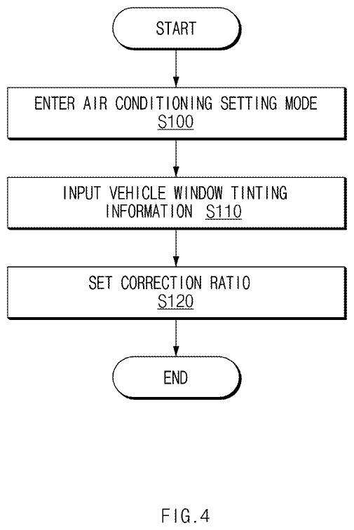

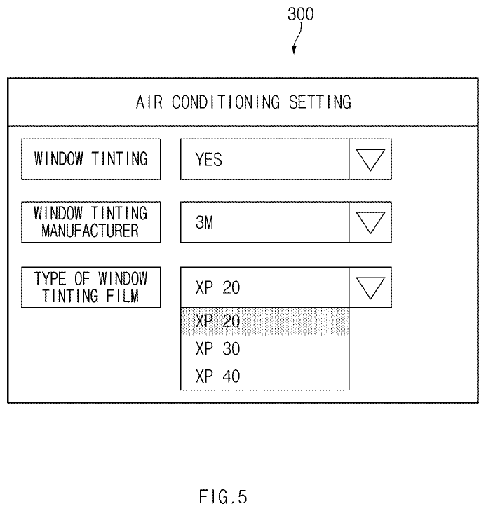

FIG. 4 is a flowchart illustrating an air conditioning setting method according to various exemplary embodiments of the present invention. FIG. 5 is a view exemplarily illustrating an example of an air conditioning setting screen related to the present invention.

In S100, the processor 160 may enter an air conditioning setting mode according to the request of a user. The processor 160 may enter the air conditioning setting mode according to a user input which is input through the user interface 130. When entering the air conditioning setting mode, the processor 160 may display an air conditioning setting screen 300 on a display as shown in FIG. 5.

In S110, the processor 160 may receive vehicle window tinting information through the user interface 130. The processor 160 may select the presence or absence of window tinting, the tinting manufacturer and/or the type of window tinting film according to a user input through the air conditioning setting screen 300. The processor 160 may receive the selected information as window tinting information.

The processor 160 may set a correction ratio based on the input window tinting information in S120. The processor 160 may determine the correction ratio corresponding to the window tinting information with reference to the database stored in the memory 140. Furthermore, the processor 160 may store the set correction ratio in the memory 140.

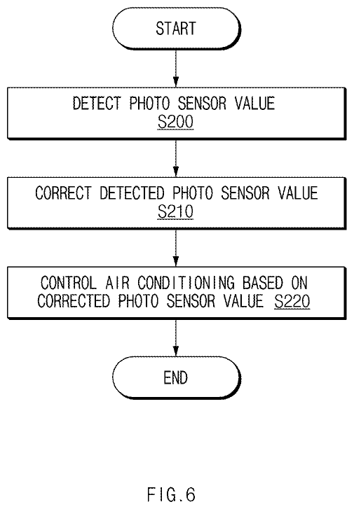

FIG. 6 is a flowchart illustrating an air conditioning control method according to various exemplary embodiments of the present invention.

In S200, the processor 160 may detect a photo sensor value by use of the photo sensor 110. When power is supplied to the vehicle, the processor 160 may operate the photo sensor 110 to detect the photo sensor value.

In S210, the processor 160 may correct the detected photo sensor value by use of a preset correction ratio. The processor 160 may determine the corrected photo sensor value by multiplying the photo sensor value by the preset correction ratio.

In S220, the processor 160 may perform air conditioning control based on the corrected photo sensor value. The processor 160 may adjust the air condition inside the vehicle based on the corrected photo sensor value, the indoor temperature and/or the outdoor temperature.

In the exemplary embodiment described above, the air conditioning control performed using the corrected photo sensor value is referred to as an example, but the exemplary embodiment is not limited thereto. An auto light function may be implemented using the corrected photo sensor value. For example, a lighting controller may turn on a headlight when the corrected photo sensor value is less than a threshold value and turn off the headlight when the corrected photo sensor value is greater than or equal to the threshold value.

According to the exemplary embodiments of the present invention, based on the window tinting specification applied to the vehicle, the photo sensor value may be corrected and the indoor air conditioning may be controlled using the corrected photo sensor value, so that it is possible to control comfortable indoor air regardless of the presence or absence of window tinting and to reduce unnecessary heating and cooling energy.

Furthermore, according to the exemplary embodiments of the present invention, it is possible to implement a more precise auto light function by use of the photo sensor value corrected based on the window tinting specification applied to the vehicle.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. An air conditioning control apparatus comprising:
a photo sensor configured to detect a quantity of insolation incident to an interior of a vehicle; and
a processor configured to:
set a correction ratio according to window tinting information of the vehicle,
correct a photo sensor value detected by the photo sensor using the set correction ratio, and
control indoor air conditioning of the vehicle according to the corrected photo sensor value.

2. The air conditioning control apparatus of claim 1, wherein the window tinting information includes at least one of whether window tinting is present, a window tinting manufacturer, or a window tinting paper type.

3. The air conditioning control apparatus of claim 1, wherein the processor is configured to determine the corrected photo sensor value by multiplying the detected photo sensor value by the set correction ratio.

4. The air conditioning control apparatus of claim 1, wherein the processor is configured to perform the air conditioning control in consideration of at least one of an outdoor temperature or an indoor temperature of the vehicle together with the corrected photo sensor value.

5. The air conditioning control apparatus of claim 1, wherein the processor is configured to control an auto light function of the vehicle based on the corrected photo sensor value.

6. The air conditioning control apparatus of claim 1, wherein the photo sensor is attached to a windshield of the vehicle or provided on an upper end portion of a crash pad of the vehicle.

7. The air conditioning control apparatus of claim 1, wherein the correction ratio is set after initial window tinting or after window tinting change.

8. The air conditioning control apparatus of claim 1,
wherein the photo sensor includes a first photodiode and a second photodiode,
wherein a cathode of the first photodiode and a cathode of the second photodiode are connected to each other,
wherein an anode of the first photodiode and an anode of the second photodiode are connected to a pull-down resistor, respectively.

9. The air conditioning control apparatus of claim 8,
wherein the first photodiode is provided at a driver's seat side and the second photodiode is provided at a passenger's seat side.

10. An air conditioning control method comprising:
setting, by a processor, a correction ratio according to window tinting information of a vehicle;
determining, by the processor, a photo sensor value corresponding to a quantity of insolation incident to an interior of the vehicle using a photo sensor;
correcting, by the processor, the detected photo sensor value using the set correction ratio; and
controlling, by the processor, indoor air conditioning of the vehicle according to the corrected photo sensor value.

11. The air conditioning control method of claim 8, wherein the window tinting information includes at least one of whether window tinting is present, a window tinting manufacturer, or a window tinting paper type.

12. The air conditioning control method of claim 10, wherein the correcting of the photo sensor value includes:
determining the corrected photo sensor value by multiplying the detected photo sensor value by the set correction ratio.

13. The air conditioning control method of claim 10, wherein the controlling of the indoor air conditioning includes:
performing the air conditioning control in consideration of at least one of an outdoor temperature or an indoor temperature of the vehicle together with the corrected photo sensor value.

14. The air conditioning control method of claim 10, further including:
controlling, by the processor, an auto light function of the vehicle based on the corrected photo sensor value.

15. The air conditioning control method of claim 10, wherein the setting of the correction ratio includes:
setting the correction ratio after initial window tinting or after window tinting change.

16. The air conditioning control method of claim 10,
wherein the photo sensor includes a first photodiode and a second photodiode, wherein a cathode of the first photodiode and a cathode of the second photodiode are connected to each other,
wherein an anode of the first photodiode and an anode of the second photodiode are connected to a pull-down resistor, respectively.

17. The air conditioning control method of claim 16,
wherein the first photodiode is provided at a driver's seat side and the second photodiode is provided at a passenger's seat side.

18. A non-transitory computer readable storage medium on which a program for performing the method of claim 10 is recorded.
